(19) United States
(12) Patent Application Publication
(10) Pub. No.: US 2009/0128993 A1
(43) Pub. Date: May 21, 2009

(54) MULTI-TIER CAPACITOR STRUCTURE, FABRICATION METHOD THEREOF AND SEMICONDUCTOR SUBSTRATE EMPLOYING THE SAME

(75) Inventors: Shih-Hsien Wu, Taoyuan County (TW); Min-Lin Lee, Hsinchu City (TW); Shinn-Juh Lai, Hsinchu County (TW); Shur-Fen Liu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Reaserch Institute, Hsinchu (TW)

(21) Appl. No.: 12/173,032

(22) Filed: Jul. 15, 2008

(30) Foreign Application Priority Data
Nov. 21, 2007 (TW) 96144117

(51) Int. Cl. H01G 4/38

(52) U.S. Cl. 361/329; 361/312; 438/393; 257/E21.008

(57) ABSTRACT

A multi-tier capacitor structure has at least one multi-tier conductive layer. At least one conductive via passes through the multi-tier conductive layer. When currents flow through the conductive via, different current paths are presented in the conductive via in response to different current frequency; in other words, different inductor is induced. Therefore, a single plate capacitor structure has function of hierarchical decoupling capacitor effect.

### CROSS-REFERENCE TO RELATED APPLICATION

This application claims the priority benefit of Taiwan application serial no. 96144117, filed on Nov. 21, 2007. The entirety of the above-mentioned patent application is hereby incorporated by reference herein and made a part of this specification.

### BACKGROUND OF THE INVENTION

1. Field of the Invention

The present invention relates to a multi-tier capacitor structure and a fabrication method thereof, and a semiconductor substrate employing the same.

2. Description of Related Art

An electronic circuit today, such as a computer, has powerful functions and an increasing processing speed. Along with an increasing operation frequency of the electronic circuit, the noises at the power terminal and the ground terminal thereof get more and more serious and anxious. In order to reduce the noises, a so-called decoupling capacitor is introduced and disposed between the power and the circuit.

In addition, the transient current required by a chip during the operation sometimes would be higher than the available current provided by the on-chip capacitors of the chip, which may lead to degrade the processing performance of the chip. To solve the problem, an off-chip capacitor is disposed at an appropriate position outside the chip or on the chip surface, wherein some circuit areas of the chip which may draw large transient currents are termed as ‘hot-spots’ hereinafter.

In general, the position for disposing a decoupling capacitor is preferably near to a die load or a hot spot as close as possible to enhance the performance. In particular, a decoupling capacitor is usually disposed on the die-side or the land-side of a chip. FIG. 1 is a cross-section diagram of an integrated circuit (IC) 104 with die side capacitors 106 and land side capacitors 108 in the prior art. As shown by FIG. 1, an IC 104 is disposed on a substrate 102. Die side capacitors 106 are disposed on the same surface with the IC 104, and land side capacitors 108 are disposed on opposite surface to the IC 104.

FIG. 2 is the equivalent circuit diagram of FIG. 1. The die load 202 herein represents some portions of the integrated circuit (IC) 104 which need currents provided by capacitors. The currents may be provided by an on-chip capacitor 204 of the chip 104, or by an off-chip capacitor 206 (for example, the die side capacitors 106 and the land side capacitors 108 in FIG. 1). However, due to chip packaging, the capacitor 206 must be spaced from the die load 202 by a distance, which results in an inductance effect represented by an inductor 208. If the inductance (or impedance) of the inductor 208 is getting higher, the response speed of the capacitor 206 gets slower and the ability of noise-processing of the capacitor 206 is accordingly reduced. This means the ability of noise-processing of the capacitor 206 is reduced when the inductance (or impedance) of the inductor 208 is high. As a result, the circuit efficiency is significantly affected.

To overcome the above-mentioned problem, a hierarchical capacitor structure has been developed already. FIG. 3 is a cross-section diagram of a conventional hierarchical capacitor structure and FIG. 4 is the equivalent circuit diagram of FIG. 3.

Referring to FIGS. 3 and 4, a conventional hierarchical capacitor structure 300 includes three capacitor structures 302, 304 and 306. The capacitor structure 302 is defined by layers 311-315 (including both dielectric layers and conductive layers); the capacitor structure 304 is defined by layers 316-320 (including both dielectric layers and conductive layers); the capacitor structure 306 is defined by layers 321-325 (including both dielectric layers and conductive layers). The capacitor structures 302, 304 and 306 are electrically connected to the layers 311-325 through conductive vias 330, 332 and 334, and the coupling is shown by FIG. 3.

The capacitor structures 302, 304 and 306 are electrically connected to outside circuitry by the conductive vias 330, 332, 334 and a top connector 340 and a bottom connector 342.

The quantity of the conductive vias 330, 332 and 334 passing through capacitor structures may affect the effective capacitance and the effective inductance of the capacitor structures. In detail, more the conductive vias 330, 332 and 334, less the effective capacitance and the effective inductance of the capacitor structures are; longer the conductive vias 330, 332 and 334, greater the effective inductance of the capacitor structures is. Besides, by connecting in parallel the conductive vias 330, 332 and 334, the effective inductance of the capacitor structures would be reduced.

The equivalent circuit of the capacitor structure 302 includes a capacitor 408 and an inductor 420 as shown by FIG. 4; the equivalent circuit of the capacitor structure 304 includes a capacitor 410 and an inductor 422 as shown by FIG. 4; the equivalent circuit of the capacitor structure 306 includes a capacitor 412 and an inductor 424 as shown by FIG. 4, wherein the capacitance of the three capacitors are subject to: 412>410>408 and the inductance of the three inductors are subject to 424>422>420. Since the current rate of the capacitor is affected by the current path (i.e. the inductor), therefore, the current rates of the three capacitors are subject to 408>410>412. FIG. 4 is the diagram of the equivalent circuit for the conventional hierarchical capacitor structure in FIG. 3, wherein capacitor 404 represents an on-chip capacitor.

A combination of the capacitor 408 and the inductor 420 enables the capacitor 408 competent for suppressing high-frequency noise. Since the capacitor 408 has small capacitance, the available transient current (high frequency) provided by the capacitor 408 is not large.

The current rate of the capacitor 410 is slower than that of the capacitor 408, therefore, the capacitor 410 is suitable for suppressing medium-frequency noise; the current rate of the capacitor 412 is the slowest, therefore, the capacitor 412 is suitable for suppressing low-frequency noise only.

Note that when a die load draws current, it usually draws different currents from different conductive vias. For example, the die load draws large currents from near conductive vias and draws small currents from far conductive vias. Accordingly, it suggests that assuming a number of conductive vias are disposed around a small capacitor structure (for example, 302 in FIG. 3), some of current-drawing points still may not contribute to reduce the expected effect of reducing inductance (since the conductive vias are not effectively connected in parallel). Therefore, the inductor-capacitor combination scheme of FIG. 3 (a large capacitor paired with a large inductor, and a small capacitor paired with a small inductor) may not function as expected. In addition, although the capacitor structure 304 is initially designed to be paired with the equivalent medium inductor 422, but the current path between the current-drawing point and the capacitor structure 304 is still too long, which makes the effective inductance of the capacitor structure 304 greater than the medium inductor 422, and the architecture of FIG. 3 fail to achieve the original efficiency.

In other words, for the architecture of FIG. 3, only effectively parallel-connected conductive vias can effectively reduce the inductance; however, the architecture does not assure the conductive vias in effective parallel connection, which is a real obstacle to make the architecture function as a hierarchical decoupling capacitor structure.

### SUMMARY OF THE INVENTION

The present invention is directed to a hierarchical multi-tier capacitor structure and a semiconductor substrate employing the capacitor structure, wherein the current-drawing points of a die load may be paired with current paths having minimum impedance (i.e. minimum inductance).

The present invention is also directed to a method of fabricating a multi-layer multi-tier capacitor structure capable of improving production yield and changing capacitance based on a need.

The present invention is also directed to a method of fabricating a single-layer multi-tier capacitor structure capable of improving production yield and changing capacitance based on a need.

The present invention provides a method of fabricating a multi-tier capacitor structure, the method includes: (a) providing a first conductive layer; (b) forming a first dry film on the first conductive layer and patterning the first dry film; (c) forming a second conductive layer on the first conductive layer, wherein an effective areas of the first and second conductive layers are substantially different from each other; (d) stripping away the first dry film; (e) providing a third conductive layer; (f) providing a first dielectric layer; and (g) using the first dielectric layer to bond the first, second and third dielectric layer conductive layers to obtain a double-side substrate.

Another embodiment of the present invention provides a method of fabricating a multi-tier capacitor structure, the method includes: (a) providing a double-side substrate, wherein the double-side substrate includes a first conductive layer, a first dielectric layer and a second conductive layer, and the first dielectric layer is located between the first conductive layer and the second conductive layer; (b) forming a first dry film respectively on opposite surfaces of the double-side substrate and patterning the first dry films; (c) forming a third conductive layer respectively on opposite surfaces of the double-side substrate, an effective area of the third conductive layer is substantially different from that of the first and second conductive layers; (d) stripping away the first dry films to form a first capacitor structure; (e) repeating steps (a)-(d) to form a second capacitor structure; (f) providing a second dielectric layer; and (g) using the second dielectric layer to bond the second capacitor structure to form a multi-tier capacitor structure. In general, the above-mentioned dielectric layers have adhesion function.

Yet another embodiment of the present invention provides a multi-tier capacitor structure which includes: a first conductive layer; a second conductive layer disposed on a surface of the first conductive layer and having an effective area substantially different from that of the first conductive layer; a third conductive layer; and a first dielectric layer located between the first conductive layer and the third conductive layer and further located between the second conductive layer and the third conductive layer, respectively. The first conductive layer, the first dielectric layer and the third conductive layer herein together define a first capacitor; and the second conductive layer, the first dielectric layer and the third conductive layer together define a second capacitor.

Yet another embodiment of the present invention provides a capacitor structure, which includes: a plurality of conductive layers, wherein at least one of the conductive layers is a multi-tier conductive layer, the conductive layers are separated by a first dielectric layer and the conductive layers are grouped into a first conductive layer group and a second conductive layer group; a first conductive via going through at least one of the conductive layers, wherein the first conductive via is electrically connected to the first conductive layer group and the first conductive via is non-electrically connected to the second conductive layer group; and a second conductive via going through at least one of the conductive layers, wherein the second conductive via is electrically connected to the second conductive layer group and the second conductive via is non-electrically connected to the first conductive layer group. The conductive layers in the first conductive layer group and the conductive layers in the second conductive layer group are alternately arranged.

Yet another embodiment of the present invention provides a semiconductor substrate, which includes a multi-tier capacitor structure disposed on a surface of the semiconductor substrate or embedded in the semiconductor substrate. The multi-tier capacitor structure includes: a first conductive layer; a second conductive layer disposed on a surface of the first conductive layer and having an effective area substantially different from that of the first conductive layer; a third conductive layer and a first dielectric layer located between the first conductive layer and the third conductive layer and further located between the second conductive layer and the third conductive layer, respectively. The first conductive layer, the first dielectric layer and the third conductive layer herein together define a first capacitor, and the second conductive layer, the first dielectric layer and the third conductive layer together define a second capacitor.

Yet another embodiment of the present invention provides a semiconductor substrate, which includes a capacitor structure disposed on a surface of the semiconductor substrate or embedded in the semiconductor substrate. The capacitor structure includes: a plurality of conductive layers, wherein at least one of the conductive layers is a multi-tier conductive layer, the conductive layers are separated by a first dielectric layer and the conductive layers are grouped into a first conductive layer group and a second conductive layer group; a first conductive via going through at least one of the conductive layers, wherein the first conductive via is electrically connected to the first conductive layer group and the first conductive via is non-electrically connected to the second conductive layer group; and a second conductive via going through at least one of the conductive layers, wherein the second conductive via is electrically connected to the second conductive layer group and the second conductive via is non-electrically connected to the first conductive layer group. The conductive layers in the first conductive layer group and the conductive layers in the second conductive layer group are alternately arranged.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-section diagram of an IC 104 with a die side capacitor 106 and a land side capacitor 108 in the prior art.

FIG. 2 is the equivalent circuit diagram of FIG. 1.

FIG. 3 is a cross-section diagram of a conventional hierarchical capacitor structure.

FIG. 4 is the equivalent circuit diagram of FIG. 3.

FIG. 5A and FIG. 5B are cross-section diagrams of a multi-tier capacitor structure according to an embodiment of the present invention.

FIG. 5C is a diagram of a 2-tier conductive layer structure 580.

FIG. 5D is a diagram of a 3-tier conductive layer structure 590.

FIGS. 6A-6C are diagrams showing the current paths of the capacitor structure of FIG. 5 respectively corresponding to high-frequency, medium-frequency and low-frequency and the equivalent circuits thereof.

FIGS. 7A-7F are diagrams of modifications of the capacitor structure in the embodiment.

FIG. 8 is a diagram of a multi-layer multi-tier capacitor structure 800 according to another embodiment of the present invention.

FIGS. 9A-9H are diagrams showing the fabrication process of a multi-tier capacitor structure according to another embodiment of the present invention.

FIGS. 10A-10H are diagrams showing the fabrication process of a multi-tier capacitor structure according to yet another embodiment of the present invention.

FIG. 11 is a diagram of a capacitor structure 1100 according to another embodiment of the present invention.

FIG. 12 is a diagram of a capacitor structure 1200 according to yet another embodiment of the present invention.

FIG. 13 is a diagram of a multi-layer multi-tier capacitor structure 1300 according to yet another embodiment of the present invention.

FIG. 14A is a diagram of a conventional single-plate capacitor structure 1400A.

FIG. 14B is a diagram of a conventional 3-plate capacitor structure 1400B.

FIG. 14C is a diagram of a multi-tier plate capacitor structure 1400C according to yet another embodiment of the present invention.

FIG. 15 is a diagram showing the impedance characteristics curves of a capacitor structure of the above-mentioned embodiment and a conventional capacitor structure, respectively.

FIG. 16 is a cross-section diagram showing an IC package 1604, a silicon interposer 1606, a socket 1608 and a PC board (printed circuit board, PCB) 1610.

FIG. 17A is a diagram showing the melt flow during fabricating a single-tier plate capacitor according to the conventional process.

FIG. 17B is a diagram showing the melt flow during fabricating a single-tier plate capacitor according to the process of an embodiment of the present invention.

FIG. 18A is a diagram showing the melt flow during fabricating a multi-tier plate capacitor according to the conventional process.

FIG. 18B is a diagram showing the melt flow during fabricating a multi-tier plate capacitor according to the process of an embodiment of the present invention.

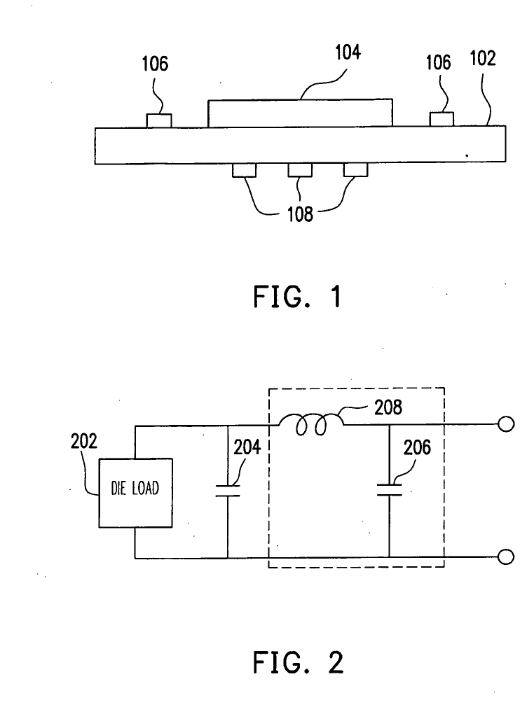

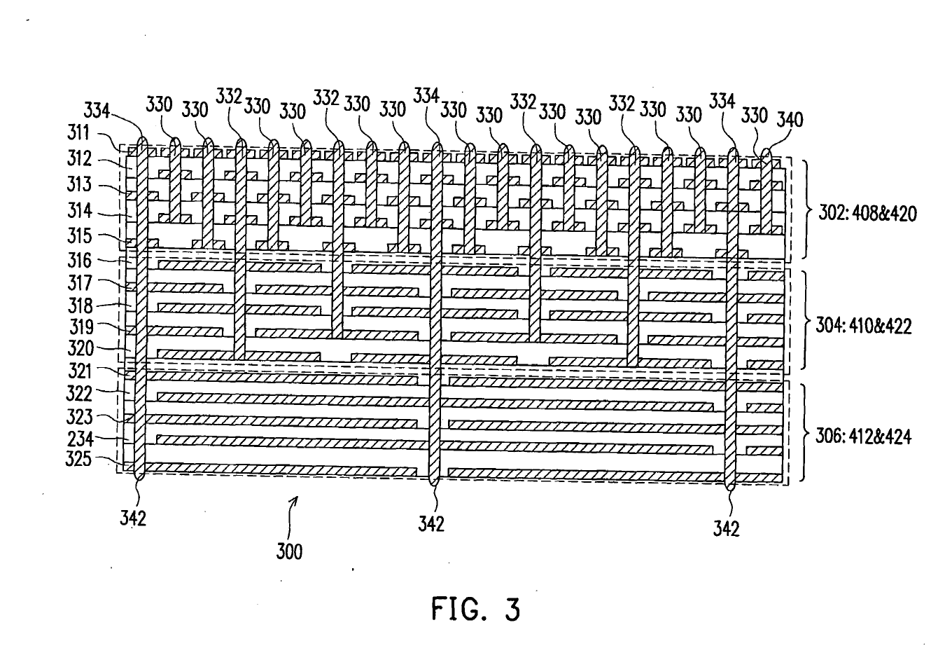

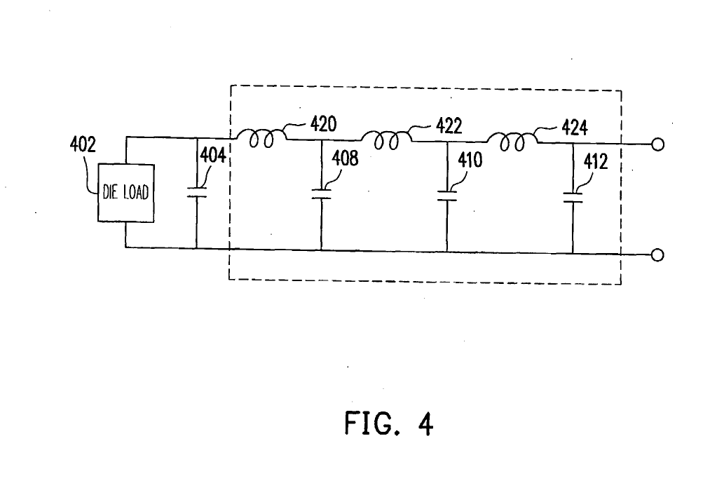

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

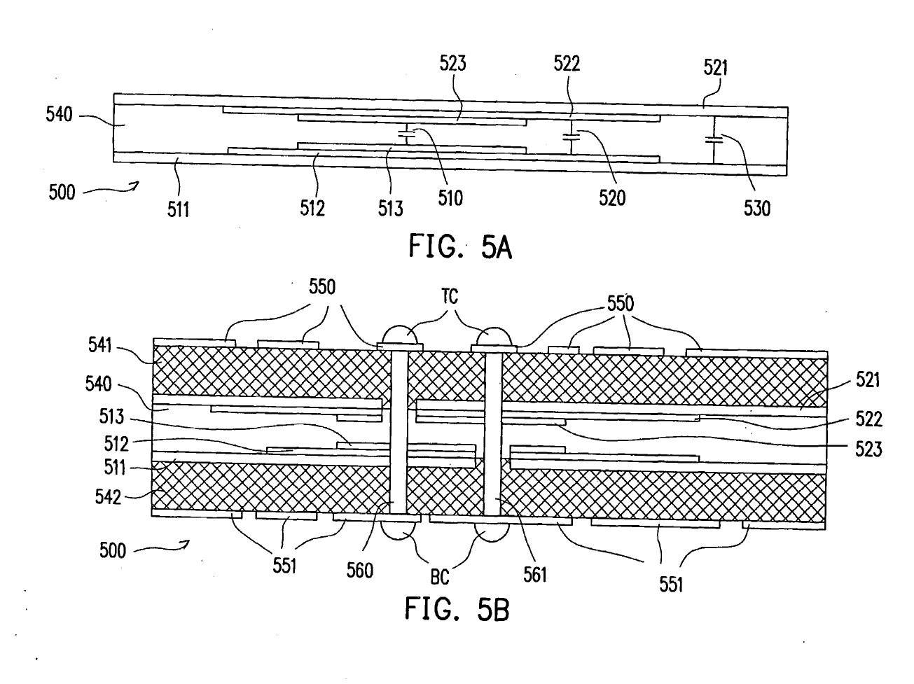

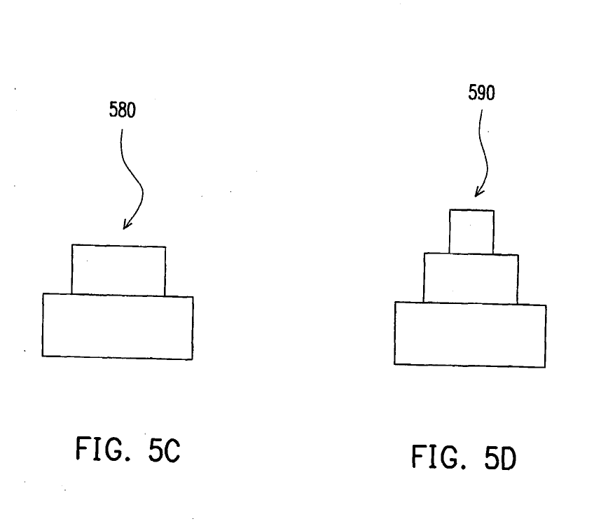

Referring to FIGS. 5A and 5B, they are cross-section diagrams of a multi-tier capacitor structure according to an embodiment of the present invention. As shown by FIG. 5A, a multi-tier capacitor structure 500 includes a dielectric layer 540, conductive layers 511, 512, 513, 521, 522 and 523. The conductive layers 511, 512 and 513 herein are served as lower conductive layers and the conductive layers 521, 522 and 523 are served as upper conductive layers. The three upper conductive layers or the three lowers together are respectively termed as a 3-tier conductive layer structure.

The effective areas of the conductive layers 511, 512 and 513 are different from each other, and the effective areas of the conductive layers 521, 522 and 523 are different from each other too. In more detail, the effective area of the conductive layer 511 is, for example, less than that of the conductive layers 512 and 513; the effective area of the conductive layer 512 is, for example, less than that of the conductive layer 513. However, all embodiments of the present invention are not limited to the above-mentioned relationships.

The plate capacitor 510 is defined by the dielectric layer 540 and the conductive layers 511 and 521. The plate capacitor 520 is defined by the dielectric layer 540 and the conductive layers 512 and 522. The plate capacitor 530 is defined by the dielectric layer 540 and the conductive layers 513 and 523. It can be seen from FIG. 5A, the capacitances of the plate capacitors 510, 520 and 530 are subject to: 510<520<530; but anyone skilled in the art should know that the capacitances are changeable by changing the effective areas and the effective distance of the conductive layers. That is, the capacitance relationship of the capacitors 510-530 can be others. By means of different distance and different areas, a hierarchical capacitor structure on co-plane is made to meet the requirement of a hierarchical decoupling capacitor structure.

Referring to FIG. 5B, 551 and 550 herein represent patterned conductive layers; and TC and BC respectively represent top connector and bottom connector. The conductive via 560 and the lower conductive layers 511-533 are electrically connected to one of the ground terminal VSS and the power terminal VCC; and the conductive via 561 and the upper conductive layers 521-523 are electrically connected to another one of the ground terminal VSS and the power terminal VCC. The conductive via 560 or 561 can be electrically connected to other signal terminals of the circuit (not shown). As shown by FIG. 5B, the upper conductive layers 521-523 have a through hole to allow the conductive via 560 or 561 passing through; the lower conductive layers 511-513 have also a through hole to allow the conductive via 560 or 561 passing through. In the embodiment, the upper conductive layers 521-523 are not electrically connected to the conductive via 560, but are electrically connected to the conductive via 561; the lower conductive layers 511-513 are not electrically connected to the conductive via 561, but are electrically connected to the conductive via 560.

Although the conductive via 560 in FIG. 5B passes through the three conductive layers 511-513 and the conductive via 561 passes through the three conductive layers 521-523, but anyone skilled in the art should know that the conductive via 560 or 561 only needs to pass through at least one of the multi conductive layers, i.e., the conductive via 560 or 561 does not need to pass through all the conductive layers.

The dielectric layer 541 is located between the conductive layer 550 and the conductive layer 521, and the dielectric layer 542 is located between the conductive layer 551 and the conductive layer 511.

In the description, a so-called ‘multi-tier conductive layer’ is defined in FIGS. 5C and 5D. FIG. 5C is a diagram of a 2-tier conductive layer structure 580, wherein the effective area of each conductive layer is substantially different from each other. FIG. 5D is a diagram of a 3-tier conductive layer structure 590, wherein the effective area of each conductive layer is substantially different from each other. It can be seen that in the description, ‘multi-tier capacitor structure’ means a capacitor structure includes at least one multi-tier conductive layer.

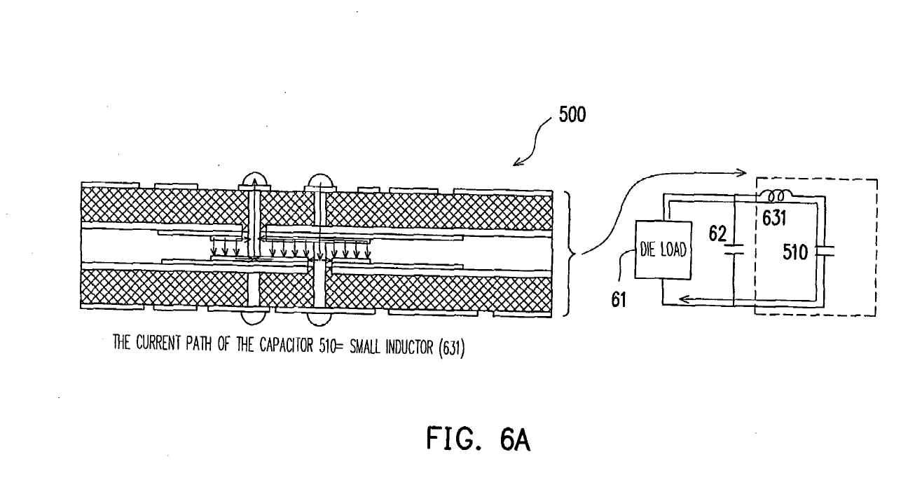

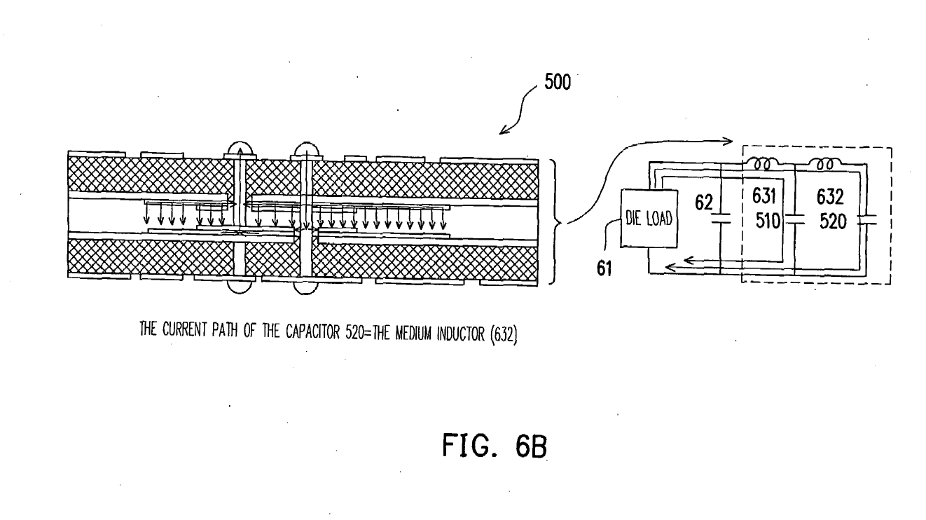

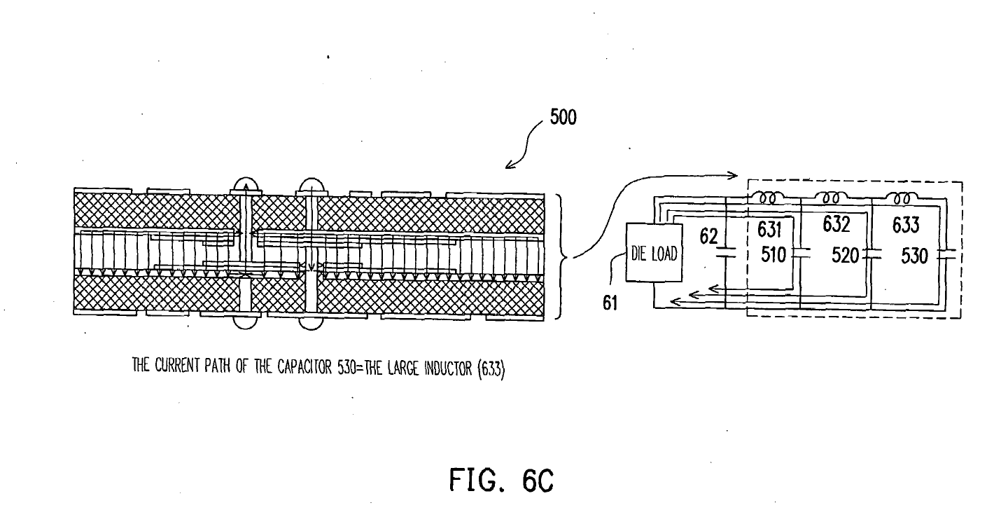

FIGS. 6A-6C are diagrams showing the current paths of the capacitor structure of FIG. 5 respectively corresponding to high-frequency, medium-frequency and low-frequency and the equivalent circuits thereof. The component 62 herein represents the on-chip capacitor of a chip (not shown). The current paths respectively passing through the capacitors 510-530 are represented respectively by inductors 631-633. It can be seen from FIGS. 6A-6C, the inductors 631-633 are subject to: 633>632>631.

As shown by FIG. 6A, when the die load 61 needs to draw high-frequency current, the capacitor 510 is able to provide high-frequency current, wherein the high-frequency noise can be suppressed by the capacitor 510 and the small inductor 631. As shown by FIG. 6B, when the die load 61 needs to draw medium-frequency current, the capacitors 510 and 520 are able to provide medium-frequency current, wherein the medium-frequency noise can be suppressed by the capacitor 510, the small inductor 631, the capacitor 520 and the medium inductor 632. As shown by FIG. 6C, when the die load 61 needs to draw low-frequency current, the capacitors 510-530 are able to provide low-frequency current, wherein the low-frequency noise can be suppressed by the capacitor 510, the small inductor 631, the capacitor 520, the medium inductor 632, the capacitor 530 and the large inductor 633.

In short, the hierarchical capacitor structure of FIG. 5 is able to effectively suppress high-frequency noise, medium-frequency noise and low-frequency noise so as to achieve the effect of suppressing wideband frequency.

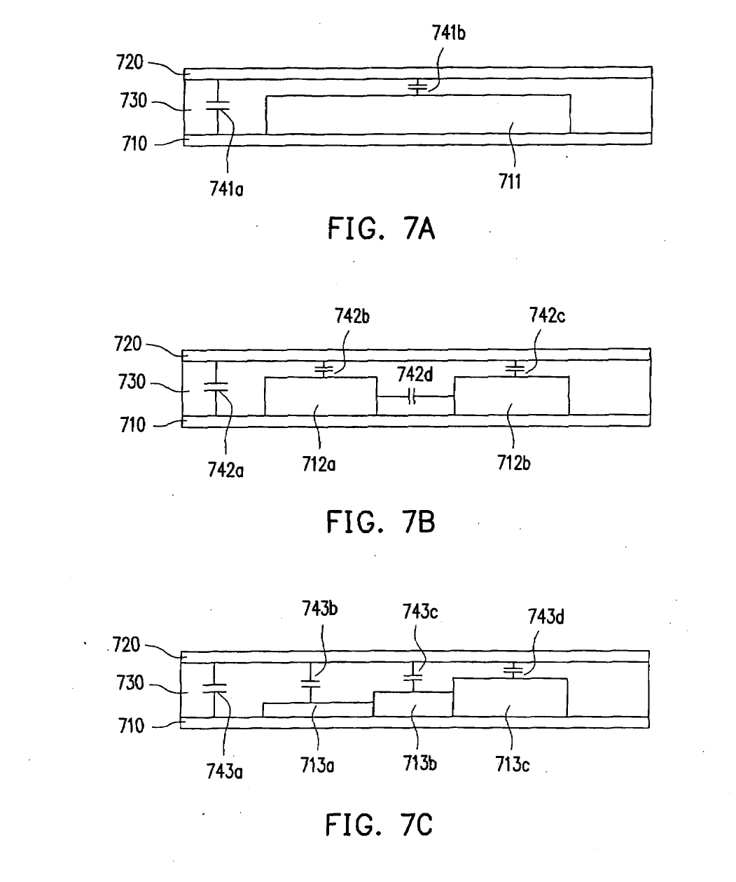

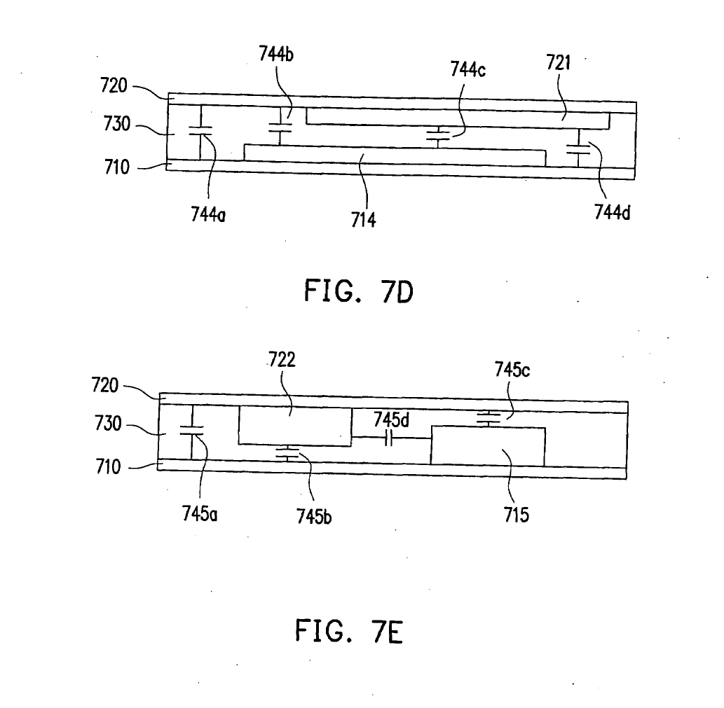

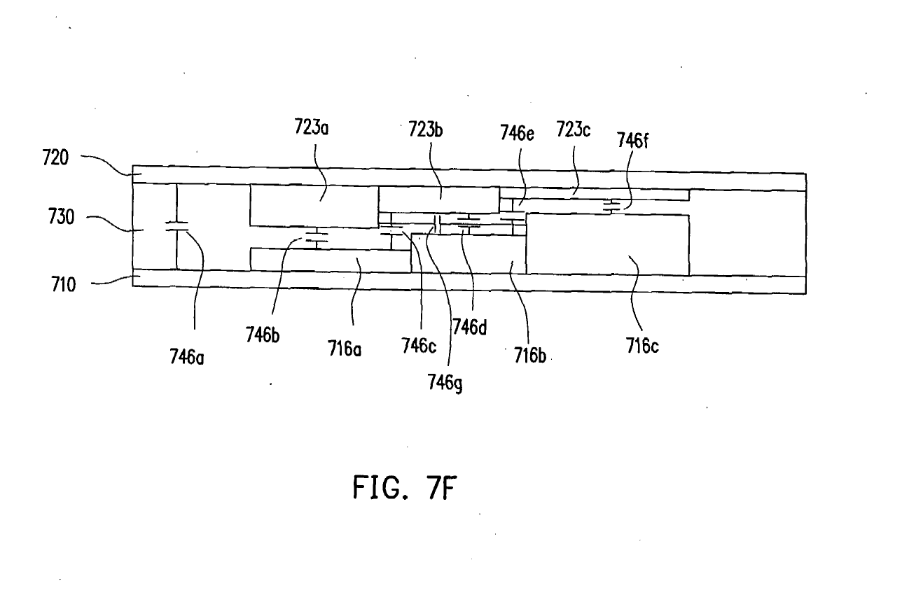

FIGS. 7A-7F are diagrams of modifications of the capacitor structure in the embodiment. 710-723c represent patterned conductive layers, 730 represents a dielectric layer and 741a-746f represent capacitors. Taking FIG. 7A as example, the conductive layers 710 and 720 define a plate capacitor 741a, and the conductive layers 711 and 720 define another plate capacitor 741b. In addition, the positions of the conductive layers are not necessarily symmetrical to each other about the dielectric layer 730, and the thicknesses of the conductive layers are not necessarily the same. For example, in FIG. 7D, the positions of the conductive layers 714 and 721 are not symmetrical to each other; in FIG. 7C, the thicknesses of the conductive layers 713a-713c are not the same; in FIG. 7E, the thicknesses of the conductive layers 715 and 722 are not necessarily the same.

Besides, by alternately arranging the upper hierarchical conductive layers and the lower hierarchical conductive layers, the side walls of the upper/lower hierarchical conductive layers would form capacitors, such as the capacitor 742d (FIG. 7B), 745d (FIG. 7E) and 746g (FIG. 7F), which makes the overall capacitance increased. When the upper/lower hierarchical conductive layers are alternately arranged, the polarities of the hierarchical conductive layers are accordingly arranged alternately. This would generate very small inductance because the magnetic fields are counteracted by each other and this would significantly contribute to enhance the high-frequency performance of the capacitor component.

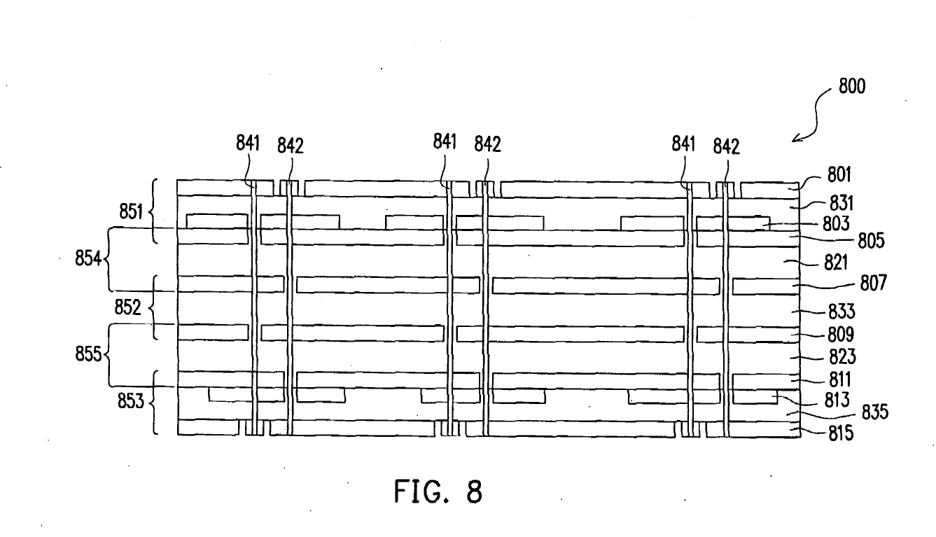

FIG. 8 is a diagram of a multi-layer multi-tier capacitor structure 800 according to another embodiment of the present invention. The capacitor structure 800 is applicable to a memory module, where, for example, the capacitor structure 800 can be embedded in the substrate of the memory module. The capacitor structure 800 includes conductive layers 801-815, dielectric layers 831-835 and conductive vias 841 and 842. The capacitor structure 800 includes multi capacitor structures, i.e., 851, 852, 853, 854 and 855. The capacitor structure 851 is defined by conductive layers 801, 803 and 805 and a dielectric layer 831, and analogically for the capacitor structures 852-855. In addition, the dielectric layer 821 can further be used to adhere the capacitor structures 851 and 852, and the dielectric layer 823 can further be used to adhere the capacitor structures 852 and 853. To be served as a dielectric layer in a metal-insulator-metal (MIM) capacitor structure, the dielectric layers 821 and 823 may be made of a material with dielectric coefficient (high Dk).

Note that although the capacitor structures 851 and 853 both located at the surface layer of the capacitor structure 800 in FIG. 8 are counted as multi-tier capacitor structures and the capacitor structure 852 located at an inner layer of the capacitor structure 800 is not counted as a multi-tier capacitor structure, but anyone skilled in the art should know that the overall capacitor structure has at least one multi-tier capacitor structure, the capacitor structure falls in the claim scope of the present invention.

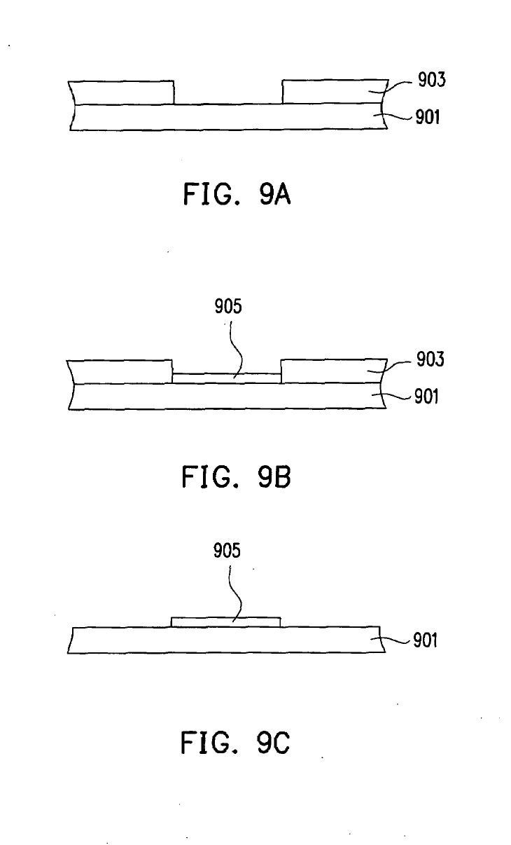

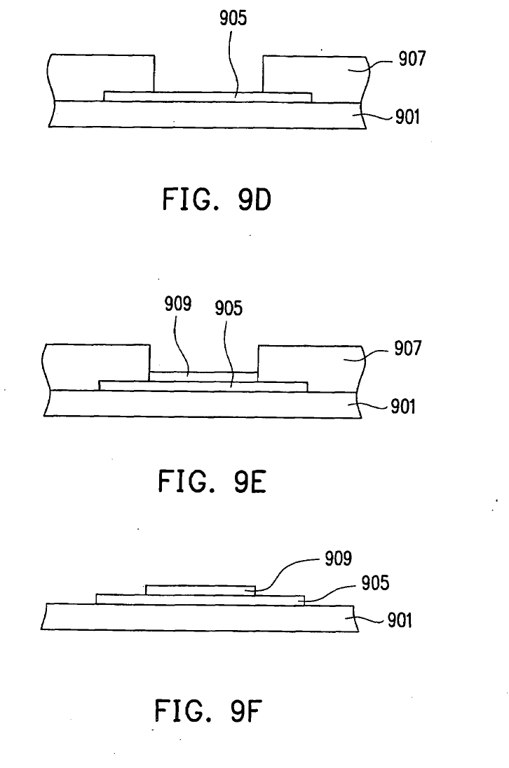

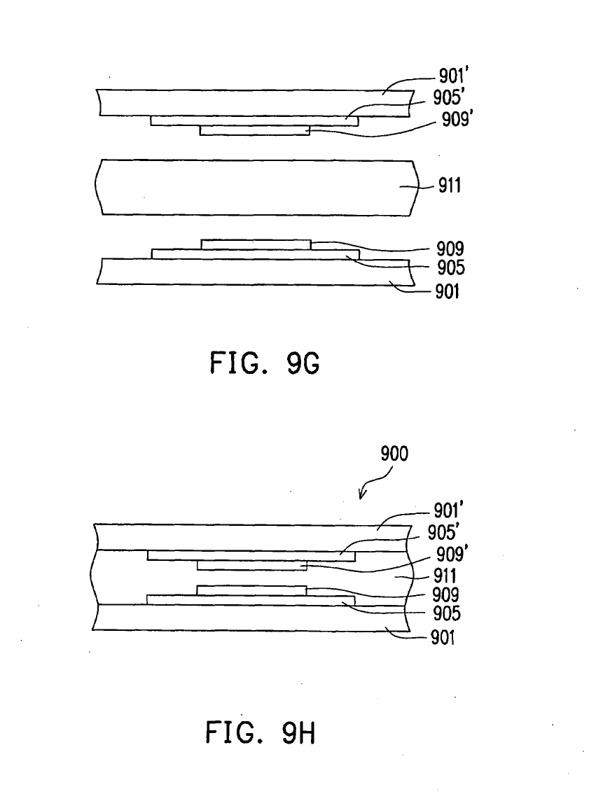

FIGS. 9A-9H are diagrams showing the fabrication process of a multi-tier capacitor structure according to another embodiment of the present invention. As shown by FIG. 9A, first, a dry film 903 is bounded onto a copper foil 901 (conductive layer) by press bounding, following by patterning the dry film 903. Next in FIG. 9B, another conductive layer 905 is plated onto the conductive layer 901, and the effective areas of the conductive layers 901 and 905 are substantially different. Then in FIG. 9C, the dry film 903 is stripped away, where a two-tier conductive layer structure including two conductive layers 901 and 905 are completed. After that, in FIG. 9D, a dry film 907 is bounded onto the dielectric layers 901 and 905 by press bounding, followed by patterning the dry film 907. Further in FIG. 9E, another conductive layer 909 is plated onto the conductive layer 905, and the effective areas of the conductive layers 901, 905 and 909 are substantially different. Furthermore in FIG. 9F, the dry film 907 is stripped away, and at the time a 3-tier conductive layer structure including conductive layers 901, 905 and 909 are completed. Analogically, the conductive layers 901′, 905′ and 909′ may be made by the process steps as shown by FIGS. 9A-9F. Finally as shown by FIG. 9G, a dielectric layer 911 which has dielectric and adhesive properties is used to press bounding the conductive layers 901-909 and the conductive layers 901′-909′ together so as to form a capacitor structure 900 as shown by FIG. 9H.

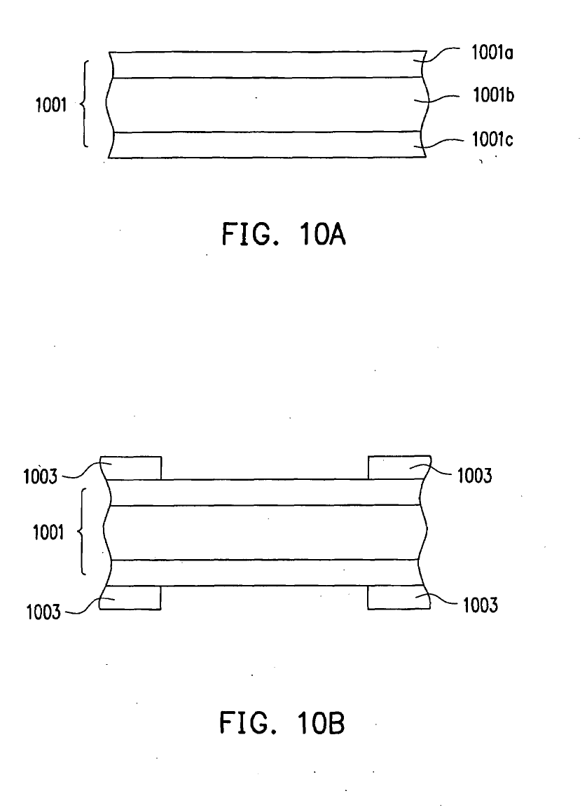

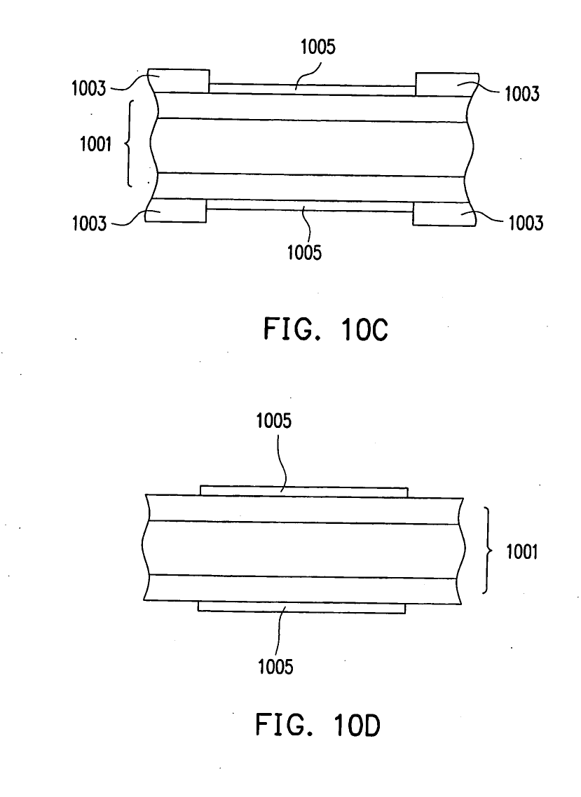

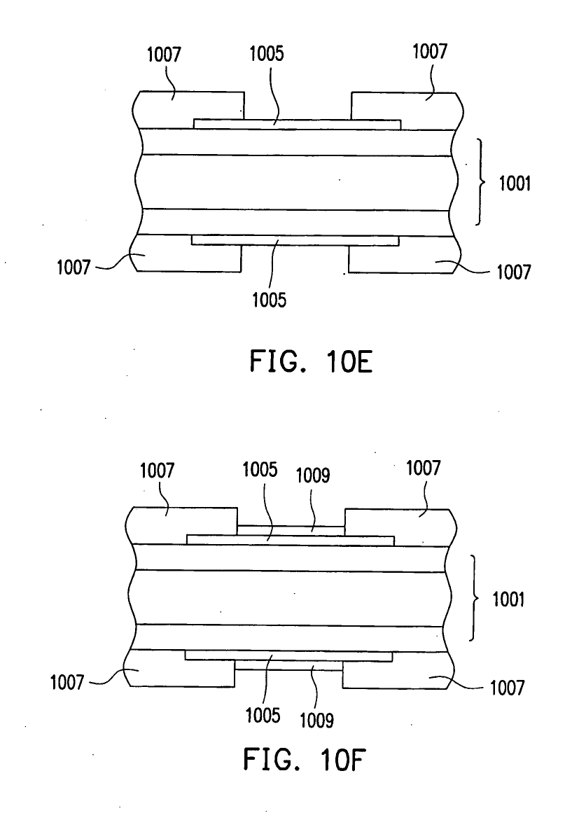

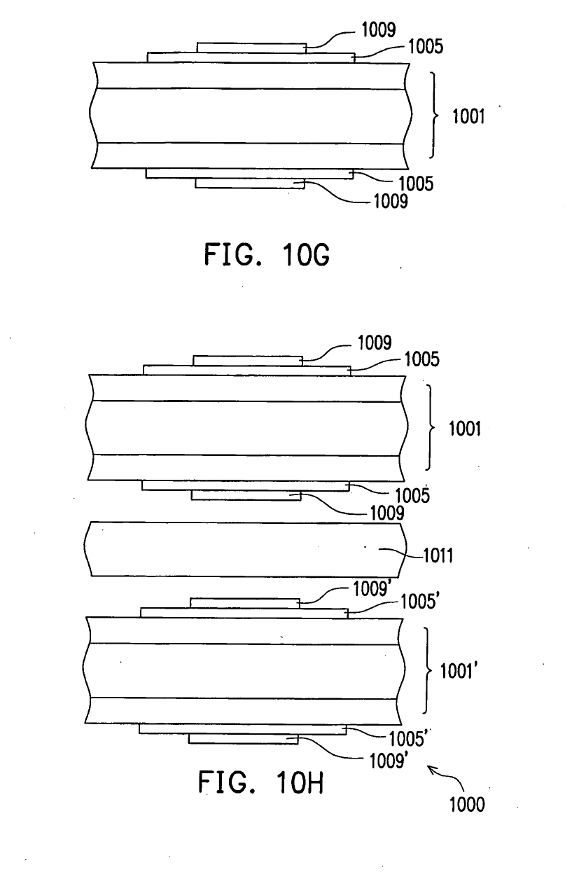

FIGS. 10A-10H are diagrams showing the fabrication process of a multi-tier capacitor structure according to yet another embodiment of the present invention. First as shown by FIG. 10A, a double-side substrate 1001 is provided, wherein the double-side substrate 1001 includes conductive layers 1001a and 1001c and a dielectric layer 1001b. The dielectric layer 100b has adhesive property and is able to adhere the conductive layers 100a and 1001c together. The double-side substrate 1001 is formed by using the dielectric layer 1001b to adhere the conductive layers 1001a and 1001c together. Next in FIG. 10B, dry films 1003 are respectively bonded onto the upper surface and the lower surface of the double-side substrate 1001, following by patterning the dry films 1003. Then in FIG. 10C, conductive layers 1005 are respectively plated on the upper surface and the lower surface of the double-side substrate 1001, and the effective areas of the conductive layers 1005 are substantially different from the effective areas of the conductive layers 1001a and 1001c. After that in FIG. 10D, the dry films 1003 are stripped away, at the time a 2-tier conductive layer structure including conductive layers 1001a/1005 and conductive layers 1001c/1005 are completed.

Further in FIG. 10E, dry films 1007 are pressed bounding on the upper and lower surfaces of the double-side substrate 1001, following by patterning the dry films 1007. Note that the architectures of FIGS. 10D and 10E are not counted as multi-tier capacitor structures yet, because the capacitances thereof are determined by the initial double-side substrate structure already and not affected by the successive multi-tier conductive layer structure. Furthermore in FIG. 10F, conductive layers 1009 are respectively plated on the upper conductive layer and the lower conductive layer 1005, wherein the effective areas of the conductive layers 1009 are substantially different from that of the conductive layers 1005. Moreover as shown by FIG. 10G, the dry films 1007 are stripped away so as to complete a 3-tier conductive layer structures respectively including the conductive layers 1001a, 1005 and 1009 and the conductive layers 1001c, 1005 and 1009. The process steps of fabricating another 3-tier conductive layer structure including 1001′, 1005′ and 1009′ may be the same as FIGS. 10A-10G. Finally as shown by FIG. 10H, the capacitor structure 1000 is formed by using a dielectric layer 1011 having dielectric and adhesive properties to press bounding the conductive layers 1001-1009 and the conductive layers 1001′-1009′ together.

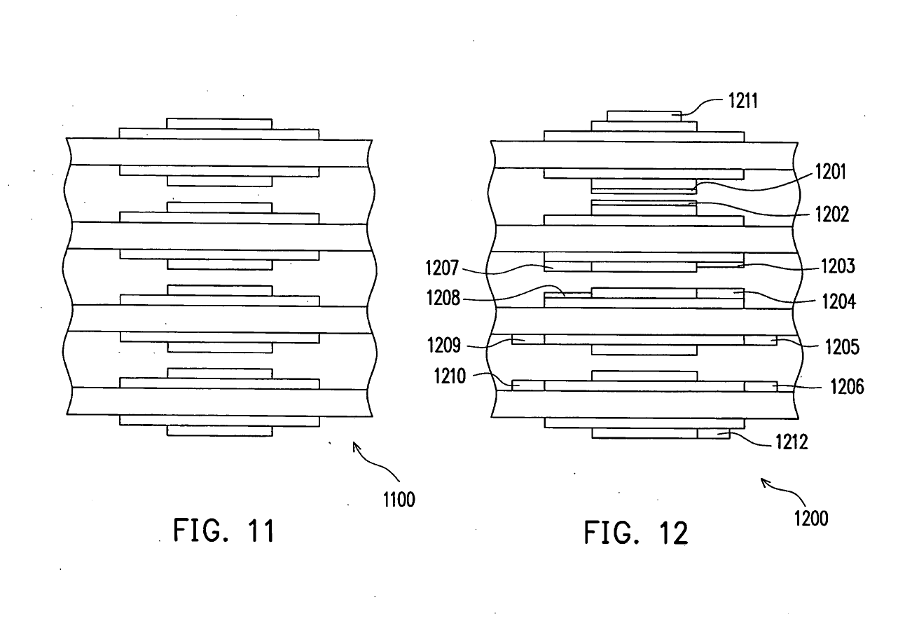

FIG. 11 is a diagram of a capacitor structure 1100 according to another embodiment of the present invention. First, for example, the capacitor structure 900 obtained by FIG. 9H is served as a double-side substrate of FIG. 10A. Next, the process of FIGS. 10B-10H are conducted on the capacitor structure 900 to obtain a capacitor structure 1100 as shown by FIG. 11. In the capacitor structure 1100, a desired hierarchical decoupling capacitor structure can be obtained by changing the effective areas of the hierarchical conductive layers in design. Moreover, a desired hierarchical decoupling capacitor structure can be obtained by changing the effective distances between the upper multi-tier conductive layers and the lower multi-tier conductive layers, and even by changing the dielectric coefficient of the dielectric layer.

FIG. 12 is a diagram of a capacitor structure 1200 according to yet another embodiment of the present invention. The dielectric coefficient of dielectric layers 1201-1212 herein is basically different from that of the dielectric layers 911, 1001b and 1011. For example, after plating of the conductive layer 905 and/or the conductive layer 909 in FIGS. 9A-9H, dielectric layers 1201-1210 are implanted at proper positions; alternatively, after plating of the conductive layers 1005, 1009, 1005′ and 1009′ as shown by FIGS. 10A-10H, dielectric layers 1211 and 1212 are implanted at proper positions. In the embodiment, the implantation technique is for example, but not limited by, inkjet printing, screen printing or sputtering.

In the capacitor structure 1200, the desired capacitance of a hierarchical decoupling capacitor structure can be obtained by changing the effective area of each multi-tier conductive layer, by changing the effective distances between the upper multi-tier conductive layer and the lower multi-tier conductive layer, by changing the dielectric coefficients of the dielectric layer or by implanting dielectric layers with different dielectric coefficients (for example, 1201-1212) in FIG. 12 on the multi-tier conductive layer or near to the multi-tier conductive layer for changing the effective dielectric coefficients between the upper multi-tier conductive layer and the lower multi-tier conductive layer.

In the processes shown by FIG. 9 or FIG. 10, dielectric layers with different dielectric coefficients can be implanted on the multi-tier conductive layer or near to the multi-tier conductive layer, for changing the effective dielectric coefficient between the upper multi-tier conductive layer and the lower multi-tier conductive layer so as to obtain a desired hierarchical decoupling capacitor structure in design.

Anyone skilled in the art should know that the processes of FIGS. 9-12 are applicable to fabricate the multi-tier capacitor structure of FIG. 5 or FIGS. 7A-7F. The processes of FIGS. 9-12 are even applicable to fabricate a multi-layer multi-tier capacitor structure.

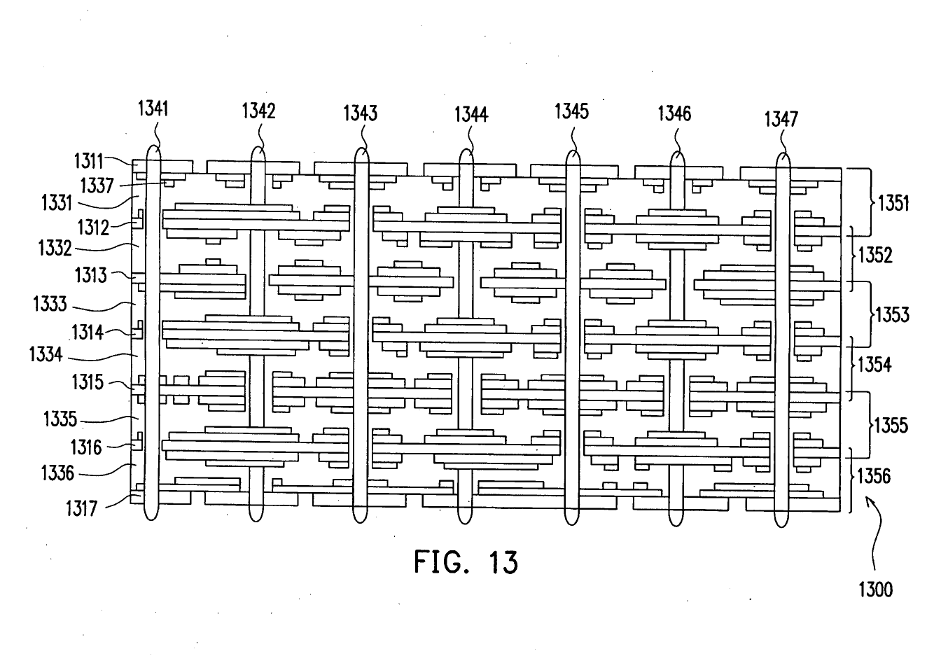

FIG. 13 is a diagram of a multi-layer multi-tier capacitor structure 1300 according to yet another embodiment of the present invention. A capacitor structure 1300 includes conductive layers 1311-1317, dielectric layers 1331-1336 and conductive vias 1341-1347. The capacitor structure 1300 includes six layers of capacitor structure 1351-1356, wherein the capacitor structure 1351 is defined by conductive layers 1311 and 1312 and a dielectric layer 1311, and analogically for the rest capacitor structures 1352-1356. In addition, the conductive layer 1312 is shared by the capacitor structures 1351 and 1352, and analogically for the rest referring to FIG. 13.

Although the conductive layers 1311-1317 in FIG. 13 are respectively counted as a multi-tier conductive structure, but anyone skilled in the art should know that the present invention is not limited thereto, but requires at least one of the conductive layers is a multi-tier conductor structure. The method of fabricating the conductive layer can refer to the above-described embodiments. Note that although the conductive vias 1341-1347 in FIG. 13 are through vias, but anyone skilled in the art should know that other types of conductive vias can be used in the present invention as well, wherein the conductive vias 1341, 1343, 1345 and 1347 are electrically connected to the conductive layers 1311, 1313, 1315 and 1317, and the conductive vias 1342, 1344 and 1346 are electrically connected to the conductive layers 1312, 1314 and 1316.

The dielectric layer 1337 in FIG. 13 (similar to FIG. 12) is disposed on the surface of at least one of the conductive layers or near to at least one of the conductive layers, and the dielectric coefficient of the conductive layer 1337 is substantially different from that of the dielectric layers 1331-1336. As described above, the dielectric layer 1337 with a different dielectric coefficient is used for changing the effective dielectric coefficient between the upper multi-tier conductive layer and the lower multi-tier conductive layer (for example, between 1311 and 1312 in FIG. 13) to obtain a desired hierarchical decoupling capacitor in design.

In addition, the conductive layers 1311-1317 can be divided into a first group of conductive layers and a second group of conductive layers, wherein the first group of conductive layers includes conductive layers 1311, 1313, 1315 and 1317, the second group of conductive layers includes conductive layers 1312, 1314 and 1316, and the conductive layers 1311, 1313, 1315 and 1417 in the first group of conductive layers and the conductive layers 1312, 1314 and 1316 in the second group of conductive layers are arranged alternately.

According to the embodiment, various desired combinations of capacitors and inductors are able to be formed by using multi-layer multi-tier capacitor structures. In addition, the multi-layer multi-tier capacitor structure in association of proper conductive vias can be used to implement a hierarchical decoupling capacitor structure capable of reducing wideband noise to meet a practical need.

On each layer of the capacitor structure, each conductive via has a different current path and is electrically connected in parallel to different capacitances. In this way, a hierarchical decoupling capacitor structure is established between each conductive via and a reference voltage (for example, the ground terminal). In practice, the conductive vias are corresponding to the pins of the power terminal or the pins of the ground terminal of an electronic circuit and this may establish a hierarchical decoupling capacitor structure between the power terminal and the ground terminal of the circuit.

In fact, the path from each conductive via to the ground terminal can be treated as a capacitor structure with a different capacitance and a different inductance, thus, the electronic circuit can be connected to an appropriate conductive via if in need.

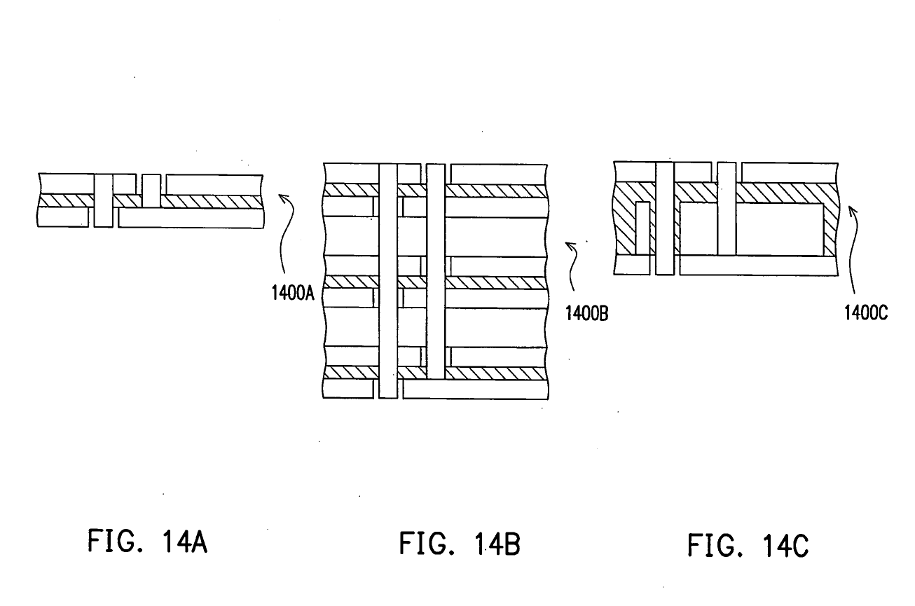

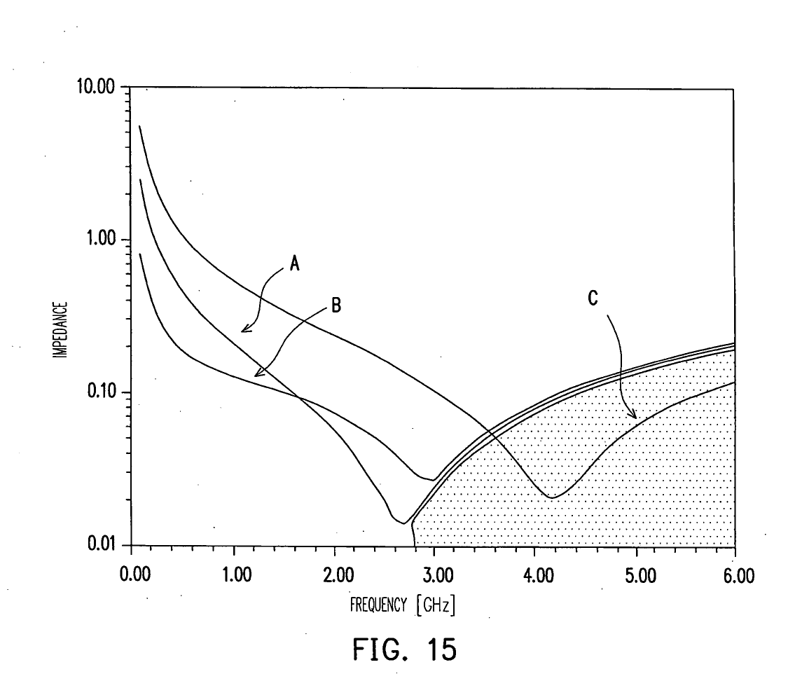

FIGS. 14A-14C and 15 are given to compare the capacitor structure of the present invention with the conventional capacitor structure. In FIG. 15, relationship curves A-C are respectively corresponding to the capacitor structures of FIGS. 14A-14C.

FIG. 14A is a diagram of a conventional single-plate capacitor structure 1400A, wherein the capacitor structure has conductive vias, and the distance between the upper layer of conductive layer structure and the lower layer of conductive layer structure is, for example, 10 μm. The capacitor structure 1400A is an ultra-thin capacitor structure, which is difficult to be fabricated by using the prior bond processes and thus the production yield is low.

FIG. 14B is a diagram of a conventional 3-plate capacitor structure 1400B, wherein the capacitor structure has conductive vias, and the 3-plate capacitor structure 1400B is formed by stacking three single-plate capacitor structure 1400A and thus the production yield is lower.

FIG. 14C is a diagram of a multi-tier plate capacitor structure 1400C according to yet another embodiment of the present invention, wherein the capacitor structure has conductive vias. It can be seen from the above-mentioned embodiments, the production yield for the multi-tier plate capacitor structure 1400C is quite high. Note that all the conductive vias in FIGS. 14A-14C are assumed to have the same specification.

The curves A and B in FIG. 15 indicate although the capacitance can be increased by parallel multi-layer, but the inductance can not be changed. It can be seen from the curve C in FIG. 15 however that the capacitor structure provided by embodiments of the present invention have reduced inductance to achieve a hierarchical capacitor having a high-frequency current path flowing through small inductance, a medium-frequency current path flowing through medium inductance and a low-frequency current path flowing through large inductance.

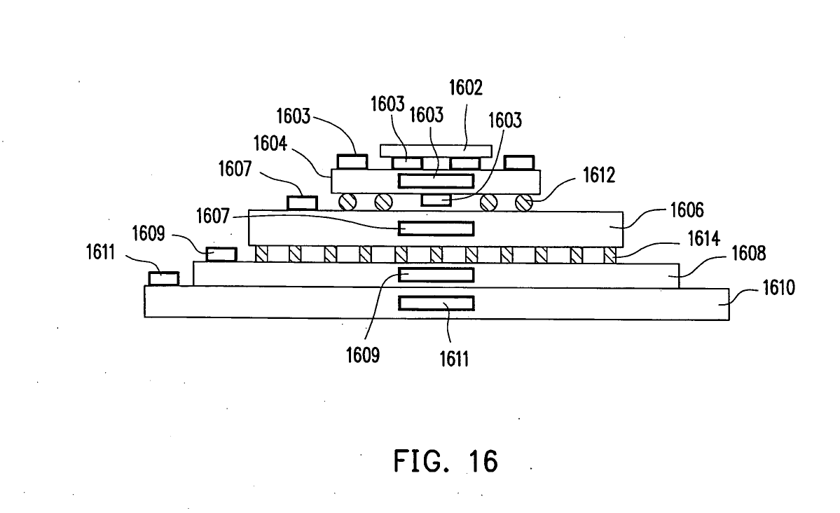

FIG. 16 is a cross-section diagram showing an IC package 1604, a silicon interposer 1606, a socket 1608 and a PC board (printed circuit board, PCB) 1610. One or more multi-tier capacitor structures provided by the above-described embodiments of the present invention are able to be embedded or integrated into the IC package 1604, the silicon interposer 1606, the socket 1608 or the PC board 1610. One or more multi-tier capacitor structures provided by the above-described embodiments of the present invention may be disposed on the surfaces of the IC package 1604, the silicon interposer 1606, the socket 1608 or the PC board 1610. “1602” represents an IC. The silicon interposer 1606 can be termed as chip carrier as well, and PCB and chip carrier are counted as one type of semiconductor substrate.

The capacitor 1603 (marked with a bold line box) can be disposed on the surface of the IC package 1604 (where the capacitor 1603 is counted as a discrete capacitor) or embedded in the IC package 1604. The capacitors 1607, 1609 and 1611 (marked with bold line boxes) can be disposed on the surfaces of the silicon interposer 1606 and/or the socket 1608 and/or the PC board 1610 (where the capacitors are counted as discrete capacitors) or embedded in the silicon interposer 1606 and/or the socket 1608 and/or the PC board 1610. In FIG. 16, the locations of the bold line boxes also represent the feasible positions to dispose or embed the capacitors according to the above-described embodiments of the present invention. That is to say, the multi-tier capacitor structure provided by the above-described embodiments of the present invention can be embedded or integrated in a housing structure.

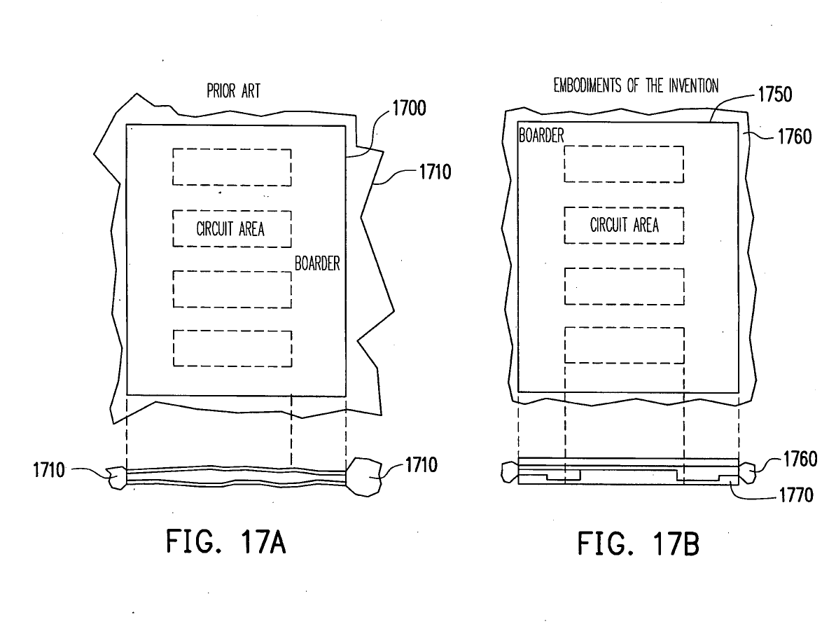

FIG. 17A is a diagram showing the melt flow during fabrication of a single-tier plate capacitor according to the conventional process and FIG. 17B is a diagram showing the melt flow during fabrication of a single-tier plate capacitor according to the above embodiments of the present invention.

As shown by FIG. 17A, in the prior art, at the boarder of a substrate 1700, no multi-tier conductive layers may serve as adhesive obstruction, and therefore, the melt flow in the prior art is uncontrollable. In contrast, as shown by FIG. 17B, since multi-tier capacitor structure is disposed at the boarder of the substrate 1700 and served as an adhesive obstruction 1770 (i.e., the multi-tier conductive layer, as shown by FIGS. 5A and 5B), therefore, the melt flow 1760 gets controlled. In other words, in the embodiments of the present invention, the multi-tier capacitor structure plays a role as an adhesive obstruction at boarders, which is able to control the melt flow produced during a press bounding process. Therefore, the thickness uniform between the upper conductive layer and the lower conductive layer located at the circuit area gets improved and moreover the distance between the upper conductive layer and the lower conductive layer can be made smaller.

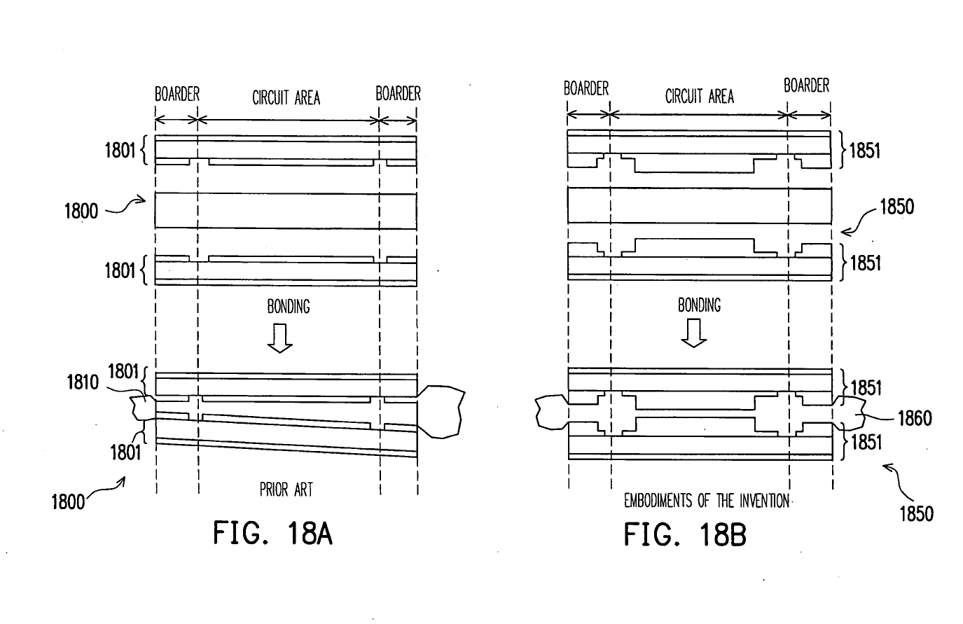

FIG. 18A is a diagram showing the melt flow during fabrication of a multi-tier plate capacitor according to the conventional process and FIG. 18B is a diagram showing the melt flow during fabrication of a multi-tier plate capacitor according to the embodiments of the present invention, wherein the double-side substrates 1801 and 1851 are in good thickness uniform.

As shown by FIG. 18A, in the prior art, the thickness of adhesive obstruction must be equal to the thickness of the conductive layer at the circuit area, so the conventional structure does not function to obstruct the melt flow. Therefore, it is not easy to control the melt flow 1810, which results in a poor thickness uniform in the conventional capacitor structure 1800. When a conventional capacitor is made on a thin substrate, the poor thickness uniform problem would be more serious.

As shown by FIG. 18B, in the process provided by the above-described embodiments of the present invention, the thickness of an adhesive obstruction is not necessarily to be same as the thickness of the circuit area. Moreover, the capacitor structures according to the above-described embodiments of the present invention may function as adhesive obstructions with different thickness, which facilitates to control the melt flow 1860 and even makes the capacitor structure 1850 has better thick uniforms. Even if a multi-tier capacitor structure according to the embodiments of the present invention is formed on a thin substrate, the thickness uniform is still good.

In the capacitor structure according to the above embodiments of the present invention, the material of a dielectric layer is unrestricted. For example, a dielectric layer can be made of ceramic and the capacitor structure according to the above embodiments of the present invention is termed as ‘ceramic capacitor’.

In a metal-insulator-metal (MIM) capacitor structure, parallel connection of different capacitances may be achieved by the multi-tier capacitor structure having multi-tier conductive layers according to the above embodiments of the present invention.

In addition, large inductance, medium inductance and small inductance can be implemented by multi-tier conductive layers having different tier thicknesses, and this is further beneficial to reach a hierarchical capacitor structure where large inductance paths are corresponding to low-frequency current paths, medium inductance paths are corresponding to medium-frequency current paths and small inductance paths are corresponding to high-frequency current paths. In contrast, the prior art requires a plurality of conductive vias in parallel connection to achieve large inductances, medium inductances and small inductances, which fails to reach hierarchical capacitor structures where different frequency currents flow through appropriate inductances.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a multi-tier capacitor structure, comprising:
(a) providing a first conductive layer;
(b) forming a first dry film on the first conductive layer and patterning the first dry film;
(c) forming a second conductive layer on the first conductive layer, an effective area of the first conductive layer being substantially different from that of the second conductive layer;
(d) stripping away the first dry film;
(e) providing a third conductive layer;
(f) providing a first dielectric layer; and
(g) using the first dielectric layer to bond the first, second and third conductive layers together to obtain a double-side substrate.

2. The fabrication method according to claim 1, wherein the step (e) comprises:
(e1) forming a second dry film on the third conductive layer and patterning the second dry film; and
(e2) forming a fourth conductive layer on the third conductive layer, an effective area of the fourth conductive layer being substantially different from that of the third conductive layer.

3. The fabrication method according to claim 2, further comprising:
(h) implanting a second dielectric layer on at least one of surfaces of the first conductive layer, the second conductive layer, the third conductive layer and the fourth conductive layer, wherein the dielectric coefficient of the first dielectric layer is substantially different from that of the second dielectric layer.

4. The fabrication method according to claim 1, further comprising:
(i) respectively forming a third dry film on opposite surfaces of the double-side substrate and patterning the third dry films;
(j) respectively forming a fifth conductive layer on opposite surfaces of the double-side substrate, an effective area of the fifth conductive layer being substantially different from that of the first conductive layer and the third conductive layer;
(k) stripping away the third dry films to form a first capacitor structure;
(l) repeating the steps (i)-(k) to form a second capacitor structure;
(m) providing a third dielectric layer; and
(n) using the third dielectric layer to bond the first capacitor structure and the second capacitor structure together.

5. The fabrication method according to claim 4, further comprising:
(o) implanting a fourth dielectric layer on at least one of surfaces of the conductive layers in the first capacitor structure, wherein the dielectric coefficient of the fourth dielectric layer is substantially different from that of the first dielectric layer; and
(p) implanting a fifth dielectric layer on at least one of surfaces of the conductive layers in the second capacitor structure, wherein the dielectric coefficient of the fifth dielectric layer is substantially different from that of the first dielectric layer.

6. A fabrication method of a multi-tier capacitor structure, comprising:
(a) providing a double-side substrate, wherein the double-side substrate comprises a first conductive layer, a first dielectric layer and a second conductive layer, and the first dielectric layer is located between the first conductive layer and the second conductive layer;
(b) respectively forming a first dry film on opposite surfaces of the double-side substrate and patterning the first dry films;
(c) respectively forming a third conductive layer on opposite surfaces of the double-side substrate, an effective area of the third conductive layer being substantially different from that of the first conductive layer and the second conductive layer;
(d) stripping away the first dry films to form a first capacitor structure;
(e) repeating the steps (a)-(d) to form a second capacitor structure;
(f) providing a second dielectric layer; and
(g) using the second dielectric layer to bond the first capacitor structure and the second capacitor structure together to form a multi-tier capacitor structure.

7. The fabrication method according to claim 6, further comprising:
(o) implanting a third dielectric layer on at least one of surfaces of the conductive layers in the first capacitor structure, wherein the dielectric coefficient of the third dielectric layer is substantially different from that of the first dielectric layer; and
(p) implanting a fourth dielectric layer on at least one of surfaces of the conductive layers in the second capacitor structure, wherein the dielectric coefficient of the fourth dielectric layer is substantially different from that of the second dielectric layer.

8. The fabrication method according to claim 6, wherein the step (a) further comprises:
(a1) providing a fourth conductive layer;
(a2) forming a second dry film on the fourth conductive layer and patterning the second dry film;
(a3) forming a fifth conductive layer on the fourth conductive layer, an effective area of the fifth conductive layer being substantially different from that of the fourth conductive layer;
(a4) stripping away the second dry film;
(a5) providing a sixth conductive layer;
(a6) providing a fifth dielectric layer; and
(a7) using the fifth dielectric layer to bond the fourth, fifth and sixth conductive layers together to obtain a double-side substrate.

9. A multi-tier capacitor structure, comprising:
a first conductive layer;
a second conductive layer disposed on a surface of the first conductive layer, wherein an effective area of the second conductive layer is substantially different from that of the first conductive layer;
a third conductive layer; and
a first dielectric layer, located between the first conductive layer and the third conductive layer and further located between the second conductive layer and the third conductive layer, respectively,
wherein the first conductive layer, the first dielectric layer and the third conductive layer together define a first capacitor, and the second conductive layer, the first dielectric layer and the third conductive layer together define a second capacitor.

10. The multi-tier capacitor structure according to claim 9, further comprising:
a fourth conductive layer disposed on a surface of the third conductive layer, wherein an effective area of the fourth conductive layer is substantially different from that of the third conductive layer.

11. The multi-tier capacitor structure according to claim 10, wherein:
the first conductive layer, the first dielectric layer and the fourth conductive layer together define a third capacitor; and
the second conductive layer, the first dielectric layer and the fourth conductive layer together define a fourth capacitor.

12. The multi-tier capacitor structure according to claim 9, further comprising:
a first conductive via, passing through at least one of the first conductive layer, the second conductive layer and the third conductive layer, the first conductive via being electrically connected to the first conductive layer and the second conductive layer; and
a second conductive via, passing through at least one of the first conductive layer, the second conductive layer and the third conductive layer, the second conductive via being electrically connected to the third conductive layer.

13. The multi-tier capacitor structure according to claim 12, wherein:
one of the first conductive via and the second conductive via is electrically connected to a power terminal and the other one is electrically connected to a ground terminal; or
at least one of the first conductive via and the second conductive via is electrically connected to a signal terminal.

14. The multi-tier capacitor structure according to claim 9, wherein:
the multi-tier capacitor structure is a discrete capacitor; or
the multi-tier capacitor structure is embedded or integrated in a housing structure.

15. The multi-tier capacitor structure according to claim 9, wherein the multi-tier capacitor structure is a ceramic capacitor.

16. The multi-tier capacitor structure according to claim 10, further comprising:
a second dielectric layer, disposed on at least one of surfaces of the first conductive layer, the second conductive layer and the third conductive layer, wherein the dielectric coefficient of the first dielectric layer is substantially different from that of the second dielectric layer; and
a third dielectric layer, disposed on the surface of the fourth conductive layer, wherein the dielectric coefficient of the first dielectric layer is substantially different from that of the third dielectric layer.

17. A capacitor structure, comprising:
a plurality of conductive layers, wherein at least one of the conductive layers is a multi-tier conductive layer, the conductive layers are separated by a first dielectric layer and the conductive layers are grouped into a first conductive layer group and a second conductive layer group;
a first conductive via, passing through at least one of the conductive layers, wherein the first conductive via is electrically connected to the first conductive layer group of the conductive layers and the first conductive via is non-electrically connected to the second conductive layer group of the conductive layers; and
a second conductive via, passing through at least one of the conductive layers, wherein the second conductive via is electrically connected to the second conductive layer group of the conductive layers and the second conductive via is non-electrically connected to the first conductive layer group of the conductive layers;
wherein the conductive layers in the first conductive layer group and the conductive layer in the second conductive layer group are alternately arranged.

18. The capacitor structure according to claim 17, wherein:
one of the first conductive via and the second conductive via is electrically connected to a power terminal and the other one is electrically connected to a ground terminal; or
at least one of the first conductive via and the second conductive via is electrically connected to a signal terminal.

19. The capacitor structure according to claim 17, wherein:
the capacitor structure is a discrete capacitor; or
the capacitor structure is embedded or integrated in a housing structure.

20. The capacitor structure according to claim 17, wherein the capacitor structure is a ceramic capacitor.

21. The capacitor structure according to claim 17, wherein the multi-tier conductive layer is located on a surface layer or an inner layer of the conductive layers.

22. The capacitor structure according to claim 17, further comprising:
a second dielectric layer, disposed on at least one of surfaces of the conductive layers, wherein the dielectric coefficient of the first dielectric layer is substantially different from that of the second dielectric layer.

23. A semiconductor substrate, comprising:
a multi-tier capacitor structure, disposed on a surface of the semiconductor substrate or embedded in the semiconductor substrate; the multi-tier capacitor structure comprising:
a first conductive layer;
a second conductive layer disposed on a surface of the first conductive layer, wherein an effective area of the second conductive layer is substantially different from that of the first conductive layer;
a third conductive layer; and
a first dielectric layer, located between the first conductive layer and the third conductive layer and further located between the second conductive layer and the third conductive layer, respectively,
wherein the first conductive layer, the first dielectric layer and the third conductive layer together define a first capacitor, and the second conductive layer, the first dielectric layer and the third conductive layer together define a second capacitor.

24. The semiconductor substrate according to claim 23, wherein the multi-tier capacitor structure further comprises:
a fourth conductive layer disposed on a surface of the third conductive layer, wherein an effective area of the fourth conductive layer is substantially different from that of the third conductive layer.

25. The semiconductor substrate according to claim 24, wherein:
the first conductive layer, the first dielectric layer and the fourth conductive layer together define a third capacitor; and
the second conductive layer, the first dielectric layer and the fourth conductive layer together define a fourth capacitor.

26. The semiconductor substrate according to claim 23, wherein the hierarchical capacitor structure further comprises:
a first conductive via, passing through at least one of the first conductive layer, the second conductive layer and the third conductive layer, the first conductive via being electrically connected to the first conductive layer and the second conductive layer; and
a second conductive via, passing through at least one of the first conductive layer, the second conductive layer and the third conductive layer, the second conductive via being electrically connected to the third conductive layer.

27. The semiconductor substrate according to claim 26, wherein:
one of the first conductive via and the second conductive via is electrically connected to a power terminal and the other one is electrically connected to a ground terminal; or
at least one of the first conductive via and the second conductive via is electrically connected to a signal terminal.

28. The semiconductor substrate according to claim 23, wherein the multi-tier capacitor structure is a discrete capacitor.

29. The semiconductor substrate according to claim 23, wherein the multi-tier capacitor structure is a ceramic capacitor.

30. The semiconductor substrate according to claim 24, wherein the multi-tier capacitor structure further comprises:
a second dielectric layer, disposed on at least one of surfaces of the first conductive layer, the second conductive layer and the third conductive layer, wherein the dielectric coefficient of the first dielectric layer is substantially different from that of the second dielectric layer; and
a third dielectric layer, disposed on the surface of the fourth conductive layer, wherein the dielectric coefficient of the first dielectric layer is substantially different from that of the third dielectric layer.

31. The semiconductor substrate according to claim 23, wherein the semiconductor substrate is a chip carrier or a printed circuit board (PCB).

32. A semiconductor substrate, comprising:
a capacitor structure, disposed on a surface of the semiconductor substrate or embedded in the semiconductor substrate; the capacitor structure comprising:
a plurality of conductive layers, wherein at least one of the conductive layers is a multi-tier conductive layer, the conductive layers are separated by a first dielectric layer and the conductive layers are grouped into a first conductive layer group and a second conductive layer group;
a first conductive via, passing through at least one of the conductive layers, wherein the first conductive via is electrically connected to the first conductive layer group of the conductive layers and the first conductive via is non-electrically connected to the second conductive layer group of the conductive layers; and
a second conductive via, passing through at least one of the conductive layers, wherein the second conductive via is electrically connected to the second conductive layer group of the conductive layers and the second conductive via is non-electrically connected to the first conductive layer group of the conductive layers;
wherein the conductive layers in the first conductive layer group and the conductive layers in the second conductive layer group are alternately arranged.

33. The semiconductor substrate according to claim 32, wherein:
one of the first conductive via and the second conductive via is electrically connected to a power terminal and the other one is electrically connected to a ground terminal; or
at least one of the first conductive via and the second conductive via is electrically connected to a signal terminal.

34. The semiconductor substrate according to claim 32, wherein the capacitor structure is a discrete capacitor.

35. The semiconductor substrate according to claim 32, wherein the capacitor structure is a ceramic capacitor.

36. The semiconductor substrate according to claim 32, wherein the multi-tier conductive layer is located on a surface layer or an inner layer of the conductive layers.

37. The semiconductor substrate according to claim 32, wherein the capacitor structure further comprises:
a second dielectric layer, disposed on at least one of surfaces of the conductive layers, wherein the dielectric coefficient of the first dielectric layer is substantially different from that of the second dielectric layer.

38. The semiconductor substrate according to claim 32, wherein the semiconductor substrate is a chip carrier or a printed circuit board (PCB).
